(19) United States
(12) Patent Application Publication
(10) Pub. No.: US 2016/0117315 A1
(43) Pub. Date: Apr. 28, 2016

(54) Method And Apparatus For Processing Message

(71) Applicant: TENCENT TECHNOLOGY (SHENZHEN) COMPANY LIMITED, Shenzhen City (CN)

(72) Inventor: Yuyan Lu, Shenzhen (CN)

(21) Appl. No.: 14/988,979

(22) Filed: Jan. 6, 2016

Related U.S. Application Data
(63) Continuation of application No. PCT/CN2014/081548, filed on Jul. 3, 2014.

(30) Foreign Application Priority Data
Jul. 18, 2013 (CN) 201310303111.5

(51) Int. Cl. G06F 17/28; G06F 17/27; H04L 12/58

(52) U.S. Cl. CPC G06F 17/2872; H04L 51/046; G06F 17/289; G06F 17/275

(57) ABSTRACT

In a method for processing a message, a target language of a user of a mobile terminal is determined. At least one message is displayed when the at least one message is sent by a client in an Instant Messenger (IM) session. When a first operation corresponding to one message of the at least one message is detected, the message corresponding to the first operation is translated into the target language and a translation message is obtained. The translation message is displayed.

### CROSS-REFERENCE TO RELATED APPLICATIONS

This application is a continuation of International Application No. PCT/CN2014/081548, filed Jul. 3, 2014. This application claims the benefit and priority of Chinese Application No. 201310303111.5, filed Jul. 18, 2013. The entire disclosures of each of the above applications are incorporated herein by reference.

### FIELD

The present disclosure relates to Instant Messenger (IM) technologies and to a method and apparatus for processing a message.

### BACKGROUND

This section provides background information related to the present disclosure which is not necessarily prior art.

Along with the developments of network technologies, cross-language communications have become increasingly common. By using a translation function provided by an IM application, users of different languages may send messages to each other. For example, a message of a first language sent by a first user may be first translated from the first language into a second language and then sent to a second user, so as to avoid language barriers between the first user and the second user.

In conventional IM applications, source languages are configured by two users respectively before a session begins between the two users. In the session, when each message is sent by one user, the IM application calls a translation interface to translate the message from the source language of the sender to the source language of the receiver, and displays the translation of the message in a session window.

There are many messages to be translated in the session, and thus, the display of the translated messages is delayed because of the translation procedure. Further, when the translation interface is called frequently, the IM application is unstable and more apt to fail. Moreover, because the source languages of the users are configured in advance, once one of the users in the session sends the message in another language, the IM application cannot translate the message, thereby reducing the communication efficiency of the IM application.

### SUMMARY

This section provides a general summary of the disclosure, and is not a comprehensive disclosure of its full scope or all of its features.

Various embodiments of the present disclosure provide a method and apparatus for processing a message, so as to improve the stability and communication efficiency of an IM application.

A method for processing a message includes:

determining a target language of a user of a mobile terminal;

displaying at least one message when the at least one message is sent by a client in an Instant Messenger (IM) session;

when a first operation corresponding to one message of the at least one message is detected, translating the message corresponding to the first operation into the target language and obtaining a translation message; and

displaying the translation message.

An apparatus for processing a message includes:

a determining module, configured to determine a target language of a user of a mobile terminal;

a first displaying module, configured to display at least one message when the at least one message is sent by a client in an Instant Messenger (IM) session;

a translating module, when a first operation corresponding to one message of the at least one message is detected, configured to translate the message corresponding to the first operation into the target language and obtain a translation message; and

a second displaying module, configured to display the translation message.

A non-transitory machine-readable storage medium stores computer programs which, when executed by a processor, will cause the processor to do the following:

determine a target language of a user of a mobile terminal;

display at least one message when the at least one message is sent by a client in an Instant Messenger (IM) session;

when a first operation corresponding to one message of the at least one message is detected, translate the message corresponding to the first operation into the target language and obtain a translation message; and

display the translation message.

According to various embodiments of the present disclosure, when the first operation is detected, the original message corresponding to the first operation is translated and the translation message is displayed based on the original message. Therefore, the translation interface of the IM application is not called frequently, and thus, the stability and communication efficiency of the IM application are improved.

Further areas of applicability will become apparent from the description provided herein. The description and various examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a method for processing a message according to various embodiments.

FIG. 2 is a flowchart illustrating a method for processing a message according to various embodiments.

FIG. 3 is a diagram illustrating an interface of a language configuration option according to various embodiments.

FIG. 4 is a diagram illustrating interfaces displayed before and after a message is processed according to various embodiments.

FIG. 5 is a diagram illustrating an apparatus for processing a message according to various embodiments.

FIG. 6 is a diagram illustrating a terminal device according to various embodiments.

Corresponding reference numerals indicate corresponding parts throughout the several views of the drawings.

### DETAILED DESCRIPTION

Example embodiments will now be described more fully with reference to the accompanying drawings.

The following description is merely illustrative in nature and is in no way intended to limit the disclosure, its application, or uses. The broad teachings of the disclosure can be implemented in a variety of forms. Therefore, while this disclosure includes particular embodiments, the true scope of the disclosure should not be so limited since other modifications will become apparent upon a study of the drawings, the specification, and the following claims. For purposes of clarity, the same reference numbers will be used in the drawings to identify similar elements.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. The use of embodiments anywhere in this specification, including embodiments of any terms discussed herein, is illustrative only, and in no way limits the scope and meaning of the disclosure or of any exemplified term. Likewise, the disclosure is not limited to various embodiments given in this specification.

As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including but not limited to.

As used herein, the phrase “at least one of A, B, and C” should be construed to mean a logical (A or B or C), using a non-exclusive logical OR. It should be understood that one or more processes within a method may be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term “shared”, as used herein, means that some or all code from multiple modules may be executed using a single (shared) processor. In addition, some or all code from multiple modules may be stored by a single (shared) memory. The term “group”, as used herein, means that some or all code from a single module may be executed using a group of processors. In addition, some or all code from a single module may be stored using a group of memories.

The systems and methods described herein may be implemented by one or more computer programs executed by one or more processors. The computer programs include processor-executable instructions that are stored on a non-transitory tangible computer readable medium. The computer programs may also include stored data. Non-limiting embodiments of the non-transitory tangible computer readable medium are nonvolatile memory, magnetic storage, and optical storage.

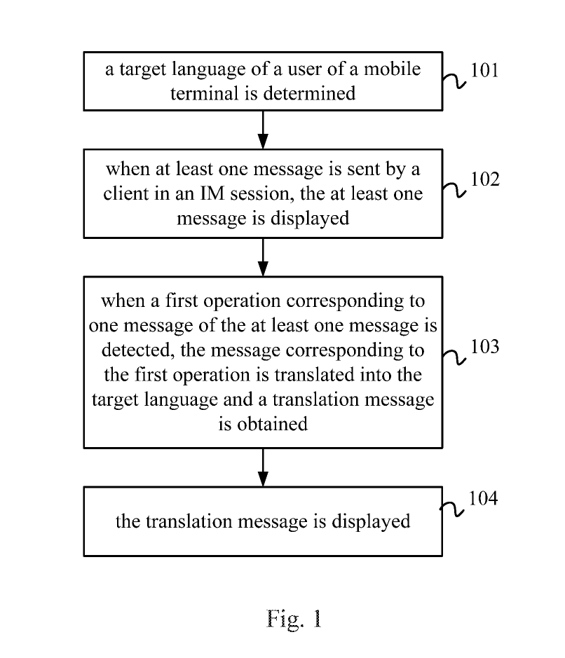

The description will be made as to the embodiments of the present disclosure in conjunction with the accompanying drawings in FIGS. 1-5. It should be understood that various embodiments described herein are merely intended to explain the present disclosure, but not intended to limit the present disclosure. In accordance with the purposes of this disclosure, as embodied and broadly described herein, this disclosure, in one aspect, relates to method and apparatus for processing a message.

Embodiments of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

In order to make the object, technical solution, and merits of the present disclosure clearer, the present disclosure will be illustrated in detail hereinafter with reference to the accompanying drawings and various embodiments.

FIG. 1 is a flowchart illustrating a method for processing a message according to various embodiments of the present disclosure. As shown in FIG. 1, the method includes the following procedures.

Block 101: A target language of a user of a mobile terminal is determined.

Block 102: When at least one message is sent by a client in an IM session, the at least one message is displayed.

Block 103: When a first operation corresponding to one message of the at least one message is detected, the message corresponding to the first operation is translated into the target language and a translation message is obtained.

Block 104: The translation message is displayed.

According to various embodiments of the present disclosure, when the first operation is detected, the original message corresponding to the first operation is translated and the translation message is displayed based on the original message. Therefore, the translation interface of the IM application is not called frequently, and thus, the stability and communication efficiency of the IM application are improved.

According to various embodiments, at block 101, an Operating System (OS) language of the mobile terminal is obtained and the OS language is determined as the target language of the user of the mobile terminal. According to various embodiments, at block 101, a language configuration option is provided for the user, and a language selected by the user via the language configuration option is determined as the target language of the user of the mobile terminal.

According to various embodiments, at block 103, when the first operation corresponding to the message of the at least one message is detected, a language of the message corresponding to the first operation is identified, and the message corresponding to the first operation is translated into the target language according to grammar rules between the identified language and the target language. The translation message is obtained.

According to various embodiments, at block 104, the translation message is displayed according to a display area of the message corresponding to the first operation. According to various embodiments, at block 104, the display area of the message corresponding to the first operation is adjusted according to the translation message, and the translation message is displayed in the adjusted display area.

According to various embodiments, after the translation message is displayed, when a second operation corresponding to the translation message is detected, the translation message is hidden, and the message corresponding to the translation message is displayed according to a display area of the translation message. According to various embodiments, the first operation is a click operation or a combination of a long-press operation and a click operation for a translation option displayed after the long-press operation. The second operation is a click operation.

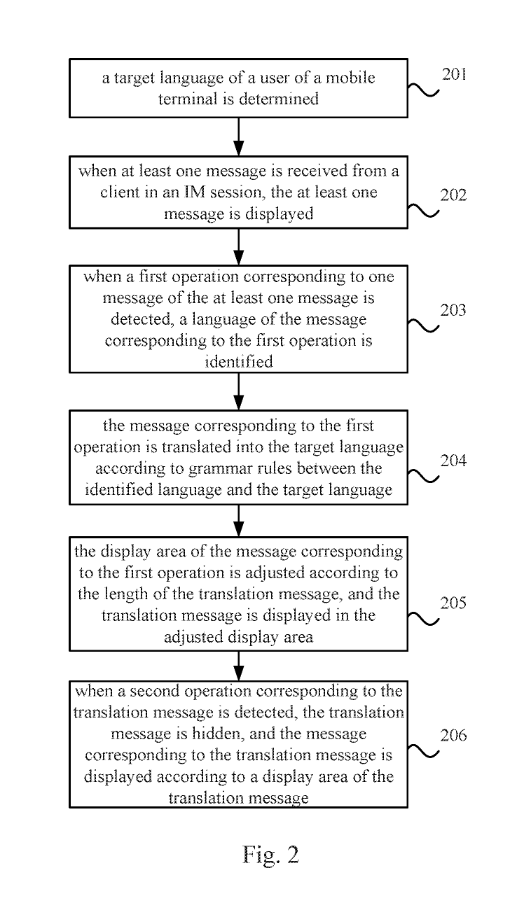

FIG. 2 is a flowchart illustrating a method for processing a message according to various embodiments of the present disclosure. In the embodiment, a mobile terminal performs the following procedures.

Block 201: A target language of a user of a mobile terminal is determined. According to various embodiments, the target language is a language of messages to be output by the mobile terminal.

According to various embodiments, one of the following two modes may be used at 201. In the first mode, an OS language of the mobile terminal is obtained and the OS language is determined as the target language of the user of the mobile terminal. The OS language is a display language configured when performing system settings for the mobile terminal. The OS language may be obtained from system parameters of the mobile terminal. Generally, the current OS language of the mobile terminal is the language used by the user of the mobile terminal. According to various embodiments, the OS language is directly obtained from the system parameters, thereby avoiding unnecessary operations, e.g. configuring the target language manually by the user.

The process at 201 may be performed when an IM application is installed into the mobile terminal or may be performed when each time an IM application client is started by the mobile terminal, i.e. the current target language of the mobile terminal is obtained each time when the IM application client is started. According to various embodiments, when the IM application is a webpage application, the current target language of the mobile terminal may be obtained each time when the IM application is started.

In the second mode, a language configuration option is provided for the user and a language selected by the user via the language configuration option is determined as the target language of the user of the mobile terminal. The language configuration option is provided by the IM application installed in the mobile terminal. When the IM application is started, the user of the mobile terminal may select one language from the language configuration option as the language used by the user of the mobile terminal. The process in the second mode may be performed after the processing in the first mode is performed. After the OS language of the mobile terminal is obtained and determined as the target language of the user of the mobile terminal, the user of the mobile terminal may change the determined target language by using the language configuration option.

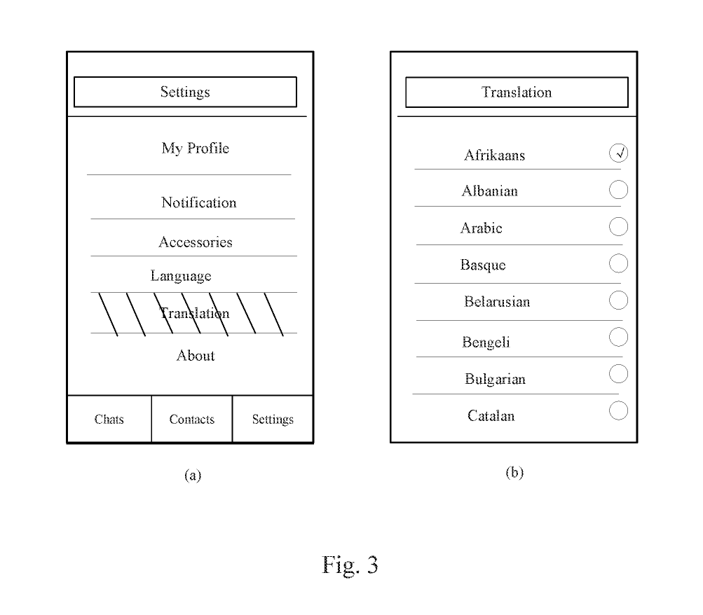

According to various embodiments, an interface of a language configuration option is provided, as shown in FIG. 3. FIG. 3(a) is an interface for configuring parameters of an IM application. Options provided by the interface include “my information”, “notice”, “attachment”, “language”, “translation”, and “about”. The option of “translation” is used for configuring the target language. After the option of “translation” is clicked, an interface for configuring the target language is shown as FIG. 3(b). Language options are provided by the interface for configuring the target language. After the user selects one language by clicking one language option corresponding to the language, e.g. the option of Afrikaans, the selected language is determined as the target language.

Block 202: When at least one message is received from a client in an IM session, the at least one message is displayed. When at least one message is received from the client in the IM session, the received message is not translated, but displayed in an original language of the message. According to various embodiments, each message is displayed in a display area by using a bubble mode.

Block 203: When a first operation corresponding to one message of the at least one message is detected, a language of the message corresponding to the first operation is identified. According to various embodiments, the first operation may be a click operation. According to various embodiments, the click operation corresponding to the message may be performed at the display area of the message. According to various embodiments, when a click operation performed at a bubble area of one message of the at least one message is detected, the language of the message corresponding to the first operation is identified.

According to various embodiments, the first operation may be a combination of a long-press operation and a click operation for a translation option displayed after the long-press operation. According to various embodiments, the long-press operation may be performed at the display area of the message. According to various embodiments, when a long-press operation is performed at a bubble area of one message of the at least one message, function options including at least a translation option are displayed. After a click operation for the translation option is detected, it is determined that the first operation corresponding to the message is determined, and the language of the message corresponding to the first operation is identified.

According to various embodiments, when the first operation corresponding to one message of the at least one message is detected, it is indicated that the user of the mobile terminal needs to translate the message, and the language of the message corresponding to the first operation is identified.

According to various embodiments, at block 203, when the first operation corresponding to one message of the at least one message is detected, the language of the message corresponding to the first operation is identified by calling a translation interface. For example, a translation interface of Google API may be called to identify the language of the message. According to various embodiments, the language of the message may be identified by detecting a target language of the client sending the at least one message in the IM session. For example, if the target language of the client sending the at least one message in the IM session is Japanese, the mobile terminal may determine that the language of the message corresponding to the first operation is Japanese by detecting the target language of the client sending the at least one message.

Block 204: The message corresponding to the first operation is translated into the target language according to grammar rules between the identified language and the target language. According to various embodiments, a translation interface may be called to use the grammar rules between the identified language and the target language, so that the message corresponding to the first operation is translated from the identified language into the target language.

According to the processes at blocks 203 and 204, when the first operation corresponding to the message of the at least one message is detected, the message corresponding to the first operation is translated into the target language.

Block 205: The display area of the message corresponding to the first operation is adjusted according to the length of the translation message, and the translation message is displayed in the adjusted display area. The message corresponding to the first operation may be called the original message, and after the original message is translated into the target language, the length of sentences in the original message and that in the translation message may be different, and the height of text in the original message and that in the translation message may be different. According to various embodiments, the display area of the original message is adjusted according to information of the translation message, e.g. the length of the sentences and the height of the text in the translation message, and the translation message is displayed in the adjusted display area. When the height of the adjusted display area is different from that of the display area of the original message, display areas of messages displayed below the original message are moved according to the height of the adjusted display area. For example, when the height of the adjusted display area is larger than that of the display area of the original message, display areas of messages displayed above the original message are not adjusted, and the display areas of messages displayed below the original message are moved down. When the height of the adjusted display area is lower than that of the display area of the original message, the display areas of messages displayed above the original message are not adjusted, and the display areas of messages displayed below the original messages are moved up. According to various embodiments, the moving distance may be changed according to configurations of the mobile terminal, so that when the translation message is displayed, the spacing between messages meets the configurations of the mobile terminal.

Block 206: When a second operation corresponding to the translation message is detected, the translation message is hidden, and the message corresponding to the translation message is displayed according to a display area of the translation message. According to various embodiments, the second operation may be a click operation. According to various embodiments, the click operation corresponding to the translation message may be performed at the display area of the translation message. According to various embodiments, when a click operation performed at a bubble area of the translation message is detected, the translation message is hidden, and the message corresponding to the translation message is displayed. When the height of the display area of the translation message is different from the height of the display area of the message corresponding to the translation message, display areas of messages displayed below the translation message are moved according to the message corresponding to the translation message. The display area of the message corresponding to the translation message is restored and displays the message corresponding to the translation message.

According to the above display restoring procedure, the user of the session may obtain not only the translation message but also the original message without interrupting the whole session. Moreover, the user may check the translation message again.

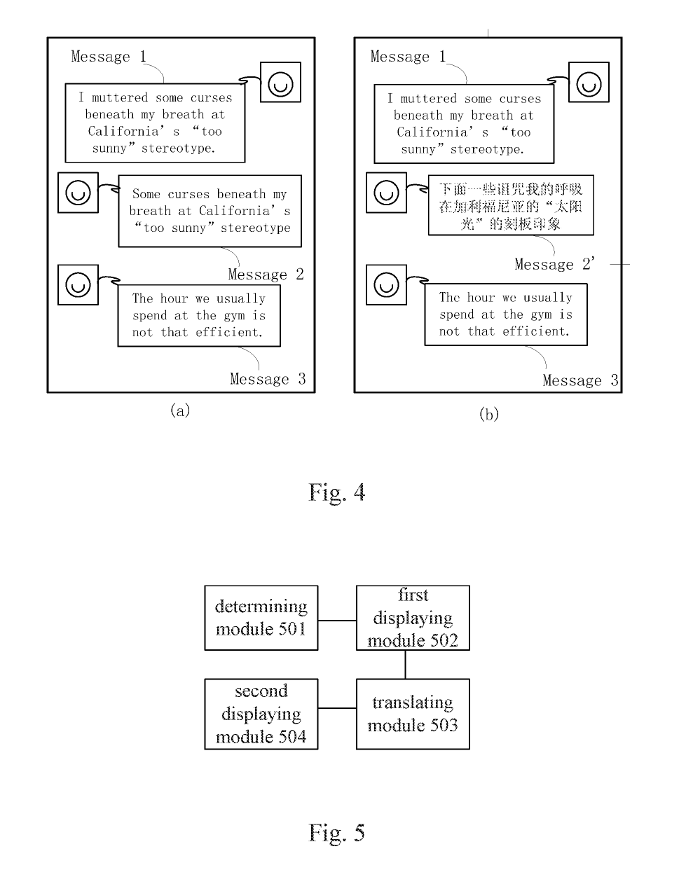

FIG. 4 is a diagram illustrating interfaces displayed before and after a message is processed according to various embodiments of the present disclosure. As shown in FIG. 4, message 1, message 2, and message 3 are displayed on a mobile terminal of a client in a session. According to various embodiments, message 2 and message 3 are sent by another client in the session, and the target language is Chinese.

When a click operation performed on a display area of message 2 is detected, the mobile terminal determines to translate message 2 and identifies the language of message 2 by calling a translation interface. After it is determined that the language of message 2 is English, the mobile terminal translates message 2 into Chinese according to English grammar and obtains message 2′. Message 2′ is a translation message of message 2. Message 2 is hidden, and the display area of message 2 is adjusted according to, for example, the height of texts in message 2′, and message 2′ is displayed on the adjusted display area. When message 2′ is displayed, if a click operation corresponding to message 2′ is detected, message 2′ is hidden, the display area is adjusted again, and message 2 is displayed on the adjusted display area.

According to various embodiments of the present disclosure, when the first operation is detected, the original message corresponding to the first operation is translated and the translation message is displayed based on the original message. Therefore, the translation interface of the IM application is not called frequently, and the stability and communication efficiency of the IM application are improved.

FIG. 5 is a diagram illustrating an apparatus for processing a message according to various embodiments of the present disclosure. As shown in FIG. 5, the apparatus includes a determining module 501, a first displaying module 502, a translating module 503, and a second displaying module 504.

The determining module 501 determines a target language of a user of a mobile terminal.

The first displaying module 502 is connected with the determining module 501 and displays at least one message when the at least one message is sent by a client in an IM session.

The translating module 503 is connected with the first displaying module 502. When a first operation corresponding to one message of the at least one message is detected, the translating module 503 translates the message corresponding to the first operation into the target language and obtains a translation message.

The second displaying module 504 is connected with the translating module 503 and displays the translation message.

According to various embodiments, the determining module 501 includes a first determining unit or a second determining unit. The first determining unit obtains an OS language of the mobile terminal and determines the OS language as the target language of the user of the mobile terminal. The second determining unit provides a language configuration option for the user and determines a language selected by the user via the language configuration option as the target language of the user of the mobile terminal.

According to various embodiments, the translating module 503 includes a language identifying unit and a translating unit. When the first operation corresponding to the message of the at least one message is detected, the language identifying unit identifies a language of the message corresponding to the first operation. The translating unit translates the message corresponding to the first operation into the target language according to grammar rules between the identified language and the target language and obtains the translation message.

According to various embodiments, the second displaying module 504 displays the translation message according to a display area of the message corresponding to the first operation. According to various embodiments, the second displaying module 504 adjusts the display area of the message corresponding to the first operation according to the translation message and displays the translation message in the adjusted display area.

According to various embodiments, the apparatus further includes a third displaying module. When a second operation corresponding to the translation message is detected, the third displaying module hides the translation message and displays the message corresponding to the translation message according to a display area of the translation message.

According to various embodiments, the first operation is a click operation or a combination of a long-press operation and a click operation for a translation option displayed after the long-press operation. The second operation is a click operation.

The above first displaying module, the second displaying module, and the third displaying module may be a display unit or a monitor of the mobile terminal.

The apparatus for processing the message is described by taking the above functional modules as examples. In practical applications, the apparatus may include different functional modules to implement all of or parts of the above described functions.

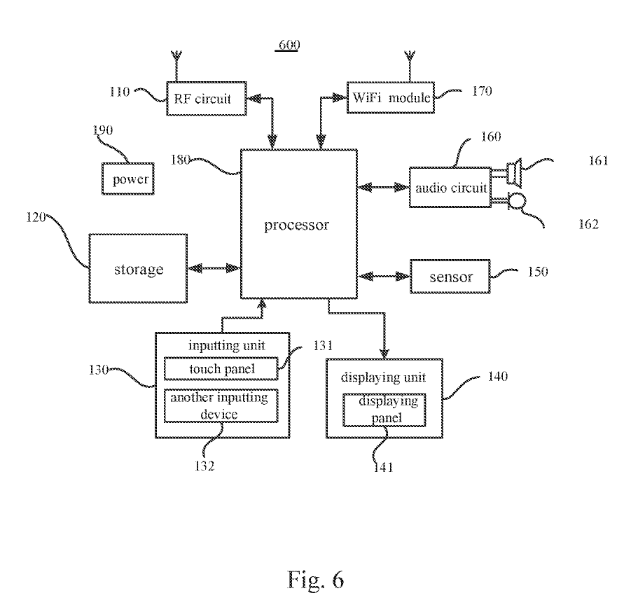

FIG. 6 is a diagram illustrating a terminal device according to various embodiments of the present disclosure. The terminal device may be used to implement the above method for processing a message.

As shown in FIG. 6, the terminal device 600 may include a Radio Frequency (RF) circuit 110, a storage 120 including at least one non-transitory machine-readable storage medium, an input unit 130, a displaying unit 140, a sensor 150, an audio circuit 160, a wireless fidelity (WiFi) module 170, a processor 180 including at least one processing core, a power 190, etc. One skilled in the art will recognize that the terminal device is not limited by a structure of the terminal device as shown in FIG. 6. According to various embodiments, the terminal device may include more components or fewer components than that shown in FIG. 6 or the terminal device may combine some of the components or may have different arrangement of the components.

The RF circuit 110 transmits and receives signals in call processes or in processes of transmitting and receiving information. The RF circuit 110 further transmits downlink information received from a base station to the processor 180. In addition, the RF circuit 110 transmits uplink data to the base station. The RF circuit 110 includes, but is not limited to, an antenna, at least one amplifier, a tuner, at least one oscillator, a subscriber identity module (SIM) card, a transceiver, a coupler, a low noise amplifier (LNA), a diplexer, etc. The RF circuit 110 communicates with a network or another communication device through wireless communication. Any of the following communication standards or protocols may be used in the wireless communication: Global System of Mobile communication (GSM), General Packet Radio Service (GPRS), Code Division Multiple Access (CDMA, Wideband Code Division Multiple Access (WCDMA), Long Term Evolution (LTE), Email, Short Messaging Service (SMS), etc.

The storage 120 stores software programs and modules. The processor 180 executes the software program and the modules stored in the storage 120 to perform function applications and data processing. The storage 120 may include a program storage area and a data storage area. The program storage area may store an operating system and an application program corresponding to at least one function (e.g., a sound playing function, a video playing function). The data storage area may store data created when the terminal device is used (e.g., audio data, contact data). In addition, the storage 120 may include a high-speed random access memory, or a non-transitory memory, such as at least one disk storage device, at least one flash memory device, or other volatile solid-state memory devices. The storage 120 may further include a memory controller, so that the processor 180 and the input unit 130 may access the storage 120.

The input unit 130 may receive an input number or character information and generate an input signal of a key, a mouse, an operating rod, an optical, or a track ball related with function control and user configuration. According to various embodiments, the input unit 130 may include a touch panel 131 and another input device 132. The touch panel 131, which is also called a touch screen, may collect a touch operation performed by a user on or near the touch panel 131 (e.g., the user may perform an operation by using any suitable object or an accessory on or near the touch panel 131), and may drive a corresponding connection device according to preset program. According to various embodiments, the touch panel 131 may include a touch detection apparatus and a touch controller. The touch detection apparatus detects a touch position, detects a signal generated by the touch operation, and transmits the signal to the touch controller. The touch controller receives touch information from the touch detection apparatus, converts the touch information to touch point coordinates, transmits the touch point coordinates to the processor 180, and receives a command from the processor 180 and executes the command. According to various embodiments, the touch panel 131 is implemented by using a resistance-type, a capacitance-type, an infrared-type, or a surface-acoustic-wave-type. In addition to the touch panel 131, the input unit 130 may further include another input device 132. The another input device 132 may include, but is not limited to, at least one of a physical keyboard, a function key (such as a volume control key, a key switch, etc.), a trackball, a mouse, and an operating rod.

The displaying unit 140 may display information input by the user, information provided to the user, or a graphical user interface of the terminal device. The graphical user interface may include at least one of a graphic, a character, an icon, a video etc. The displaying unit 140 may include a displaying panel 141. According to various embodiments, the displaying panel 141 is configured in a manner of Liquid Crystal Display (LCD), Organic Light-Emitting Diode (OLED). According to various embodiments, the touch panel 131 may cover the displaying panel 141. When detecting the touch operation on or near the touch panel 131, the touch panel 131 transmits the touch operation to the processor 180 to determine the type of a touch event. Afterwards, the processor 180 provides a corresponding visual output in the displaying panel 141. Although the touch panel 131 and the displaying panel 141 are independent components to implement an input function and an output function, according to various embodiments, the touch panel 131 and the displaying panel 141 may be integrated to implement the input function and the output function.

The terminal device 600 may further include at least one sensor 150, e.g., a light sensor, a motion sensor, and another sensor. According to various embodiments, the light sensor may include an ambient light sensor and a proximity sensor. The ambient light sensor adjusts brightness of the displaying panel 141 according to the brightness of the ambient light. The proximity sensor may close the displaying panel 141 and/or backlit when the terminal device 600 moves to an ear. As one kind of the motion sensor, an accelerometer sensor can detect a value of acceleration in all directions (typically three-axis), may detect a value and a direction of gravity in stationary, identify an application of a phone posture (such as switch between a horizontal screen and vertical screen, a related game, magnetometer posture calibration), and identify a vibration recognition related function (such as a pedometer, a percussion). Another sensor such as a gyroscope, a barometer, a hygrometer, a thermometer, or an infrared sensor may be configured in the terminal device 600, which is not described repeatedly herein.

The audio circuit 160, a speaker 161, and a microphone 162 may provide an audio interface between the user and the terminal device 600. The audio circuit 160 may transmit an electric signal transformed from received audio data to the speaker 161. The speaker 161 transforms the electric signal to a sound signal and outputs the sound signal. The microphone 162 transforms the collected sound signal to an electric signal. The audio circuit 160 receives the electric signal and transforms the electric signal to audio data and outputs the audio data to the processor 180 to be processed. After the audio data is processed by the processor 180, the audio data is transmitted to another terminal device via the RF circuit 110, or the audio data is output and stored by the memory 720 for further processing. The audio circuit 160 may further include an earphone jack, so that an earphone may communicate with the terminal device 600.

The WiFi belongs to short-range wireless transmission technology. By using the WiFi module 170 of the terminal device 600, the user may access a wireless broadband internet, transmit and receive an Email, browse a webpage and access streaming media. The wireless module 170 is shown in FIG. 6. The WiFi module 170 is not a required component of the terminal device and may be omitted as required without changing the nature of the present disclosure.

The processor 180 is a control center of the terminal device 600. The processor 180 connects all components of the terminal device via various interfaces and circuits, runs the software program and/or module stored in the memory 120, calls data stored in the memory 120, so as to execute various functions, and performs data processing for the terminal device 600. According to various embodiments, the processor 180 may include at least one processing core. According to various embodiments, the processor 180 may include an application processor and a modem processor. The application processor processes an operation system, user interfaces, and application programs. The modem processor processes wireless communication. The modem processor may not be integrated in the processor 180.

The terminal device 600 may further include a power source 190 (e.g., a battery) supplying power for each component. According to various embodiments, power source 190 may connect with the processor 180 through a power management system, so that functions, e.g., a charging management function, a discharging management function, a power management function, can be implemented through the power management system. The power 190 may further include at least one direct current power supply or alternating current power supply, a recharging system, a power failure detection circuit, a power converter and a power inverter, and a power status indicator.

The terminal device 600 may further include a camera and a blue tooth module, which is not illustrated in FIG. 6. According to various embodiments, the displaying unit of the terminal device is touch screen display. The terminal device also includes storage and at least one program. The at least one program is stored in the storage. When the at least one processor executes the at least one program, the following operations are performed. A target language of a user of a mobile terminal is determined, at least one message is displayed when the at least one message is sent by a client in an IM session, when a first operation corresponding to one message of the at least one message is detected, the message corresponding to the first operation is translated into the target language and a translation message is obtained, and the translation message is displayed.

According to various embodiments, the storage further stores instructions for performing the following operations. An OS language of the mobile terminal is obtained and the OS language is determined as the target language of the user of the mobile terminal, or a language configuration option is provided for the user and a language selected by the user via the language configuration option is determined as the target language of the user of the mobile terminal.

According to various embodiments, the storage further stores instructions for performing the following operations. When the first operation corresponding to the message of the at least one message is detected, a language of the message corresponding to the first operation is identified and the message corresponding to the first operation is translated into the target language according to grammar rules between the language identified and the target language.

According to various embodiments, the storage further stores instructions for performing the following operations. The translation message is displayed according to a display area of the message corresponding to the first operation.

According to various embodiments, the storage further stores instructions for performing the following operations. The display area of the message corresponding to the first operation is adjusted according to the translation message and the translation message is displayed in the adjusted display area.

According to various embodiments, the storage further stores instructions for performing the following operations. When a second operation corresponding to the translation message is detected, the translation message is hidden and the message corresponding to the translation message is displayed according to a display area of the translation message.

According to various embodiments, the first operation is a click operation or a combination of a long-press operation and a click operation for a translation option displayed after the long-press operation and the second operation is a click operation.

According to the above description of various embodiments, it will be understood by those skilled in the art that the present disclosure can be implemented by software accompanied with necessary general hardware platforms or by hardware. The software product is stored in a non-transitory machine-readable storage medium which may be a Read Only Memory, a disk, or a Compact Disc (DC).

The foregoing is only preferred embodiments of the present disclosure and is not used to limit the protection scope of the present disclosure. Any modification, equivalent substitution and improvement without departing from the spirit and principle of the present disclosure are within the protection scope of the present disclosure.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more procedures within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In this disclosure, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A method for processing a message, comprising:
determining a target language of a user of a mobile terminal;
displaying at least one message when the at least one message is sent by a client in an Instant Messenger (IM) session;
when a first operation corresponding to one message of the at least one message is detected, translating the message corresponding to the first operation into the target language and obtaining a translation message; and
displaying the translation message.

2. The method of claim 1, wherein determining the target language of the user of the mobile terminal comprises:
obtaining an Operating System (OS) language of the mobile terminal; and
determining the OS language as the target language of the user of the mobile terminal.

3. The method of claim 1, wherein determining the target language of the user of the mobile terminal comprises:
providing a language configuration option for the user; and determining a language selected by the user via the language configuration option as the target language of the user of the mobile terminal.

4. The method of claim 1, wherein when the first operation corresponding to the message of the at least one message is detected, translating the message corresponding to the first operation into the target language comprises:
when the first operation corresponding to the message of the at least one message is detected,
identifying a language of the message corresponding to the first operation; and
translating the message corresponding to the first operation into the target language according to grammar rules between the language identified and the target language.

5. The method of claim 1, wherein displaying the translation message comprises:
displaying the translation message according to a display area of the message corresponding to the first operation.

6. The method of claim 4, wherein displaying the translation message according to the display area of the message corresponding to the first operation comprises:
adjusting the display area of the message corresponding to the first operation according to the translation message; and displaying the translation message in the adjusted display area.

7. The method of claim 1, further comprising:
when a second operation corresponding to the translation message is detected, hiding the translation message; and displaying the message corresponding to the translation message according to a display area of the translation message.

8. The method of claim 1, wherein
the first operation is a click operation or a combination of a long-press operation and a click operation for a translation option displayed after the long-press operation;
the second operation is a click operation.

9. An apparatus for processing a message, comprising:
a determining module, configured to determine a target language of a user of a mobile terminal;
a first displaying module, configured to display at least one message when the at least one message is sent by a client in an Instant Messenger (IM) session;
a translating module, when a first operation corresponding to one message of the at least one message is detected, configured to translate the message corresponding to the first operation into the target language and obtain a translation message; and
a second displaying module, configured to display the translation message.

10. The apparatus of claim 9, wherein the determining module comprises:
a first determining unit, configured to obtain an Operating System (OS) language of the mobile terminal and determine the OS language as the target language of the user of the mobile terminal.

11. The apparatus of claim 9, wherein the determining module comprises:
a second determining unit, configured to provide a language configuration option for the user, and determine a language selected by the user via the language configuration option as the target language of the user of the mobile terminal.

12. The apparatus of claim 9, wherein the translating module comprises:
a language identifying unit, when the first operation corresponding to the message of the at least one message is detected, configured to identify a language of the message corresponding to the first operation;
a translating unit, configured to translate the message corresponding to the first operation into the target language according to grammar rules between the language identified and the target language; and obtain the translation message.

13. The apparatus of claim 12, wherein the second displaying module is configured to display the translation message according to a display area of the message corresponding to the first operation.

14. The apparatus of claim 13, wherein the second displaying module is configured to adjust the display area of the message corresponding to the first operation according to the translation message; and display the translation message in the adjusted display area.

15. The apparatus of claim 9, further comprising:
a third displaying module, when a second operation corresponding to the translation message is detected, configured to hide the translation message, and display the message corresponding to the translation message according to a display area of the translation message.

16. The apparatus of claim 9, wherein
the first operation is a click operation or a combination of a long-press operation and a click operation for a translation option displayed after the long-press operation;
the second operation is a click operation.

17. A non-transitory machine-readable storage medium, storing computer programs, which, when executed by a processor, will cause the processor to
determine a target language of a user of a mobile terminal;
display at least one message when the at least one message is sent by a client in an Instant Messenger (IM) session;
when a first operation corresponding to one message of the at least one message is detected, translate the message corresponding to the first operation into the target language and obtain a translation message; and
display the translation message.
